(19) United States
(12) Patent Application Publication
(10) Pub. No.: US 2010/0278984 A1
(43) Pub. Date: Nov. 4, 2010

(54) Health characteristic non-standardized or standardized high cocoa dark chocolate with improved taste texture, melt, creaminess and reduced bitterness

(76) Inventor: Erin Ervin, Naples, FL (US)

Correspondence Address: Erin Ervin, 3431 8th Ave. SE., Naples, FL, 34117, US

(21) Appl. No.: 12/756,901

(22) Filed: Apr. 8, 2010

Related U.S. Application Data
(60) Provisional application No. 61/168,158, filed on Apr. 9, 2009.
(60) Provisional application No. 61/171,392, filed on Apr. 21, 2009.

(51) Int. Cl. A23G 1/32; A23P 1/10

(52) U.S. Cl. 426/330; 426/541

(57) ABSTRACT

The present invention provides for a non-standardized dark chocolate composition to have up to 75% less saturated fat content than regular dark chocolate and have an improved healthier fat structure. A non-standardized and standardized dark chocolate include an antioxidant blend of; Virgin Coconut Oil, Vanilla Powder, Blackberry Powder, and Acai Berry Extract that creates a synergistic affect making the compositions have the rich and creamy taste, texture, melt and creaminess similar to milk chocolate. The final compositions have improved health characteristics, antioxidant content, and significantly less bitterness. Additionally, the method for preparing such non-standardized and standardized dark chocolate compositions is covered.

### FIELD OF THE INVENTION

The present application claims the benefit of U.S. Provisional Application Ser. No. 61/168,158 filed Apr. 9, 2009 and U.S. Provisional Application Ser. No. 61/171,392 filed Apr. 21, 2009 which are incorporated herein by reference thereto.

### BACKGROUND OF THE INVENTION

This invention relates generally to ingestible confectionery compositions based on a non-standardized or standardized high cocoa dark chocolate primary component, particularly to non-standardized and standardized high cocoa dark chocolate compositions that have improved health characteristics, a synergistic higher antioxidant blend, improved taste, improved texture, improved melt, creamier taste, reduced bitterness, lower saturated fat, and a better balance of dietary fats. It is widely now understood that high cocoa dark chocolate has a high level of antioxidants and offers users certain heart health benefits associated with these antioxidants. Below are several links to medical institutions that reference the heart health benefits of high cocoa dark chocolate.

Cocoa is naturally high in antioxidants, thus as the % of cocoa in a chocolate composition increases, levels of antioxidants also increase. However, as the cocoa percentage is increased in a dark chocolate composition the product tends to become bitter, more brittle, less creamy, and exhibits an increasingly chalky texture. To ameliorate the taste and texture issues associated with high % cocoa compositions, most chocolate producers resort to one of two methods to combat bitterness and texture problems and both of these methods have negative nutritional and health implications.

1) The incorporation and processing of cocoa solids with alkali. While the incorporation of alkali processed cocoa solids may achieve the objective of improving taste and texture they do so at the expense of sacrificing antioxidants. This is because processing cocoa with alkali destroys 40% to 90% of beneficial antioxidants.

2) The incorporation of cocoa seed butter or milk fat. While the incorporation of high levels of Cocoa seed butter or milk fat in a high cocoa dark chocolate composition may achieve the objective of improving taste and texture, it does so at the expense of adding high levels of saturated fat to the composition. This is because Cocoa seed butter and milk fat are inherently extremely high in saturated fat. Where the method of increasing cocoa seed butter called couvertures or adding milk fat is used to address taste and texture issues, saturated fat content rises in the high cocoa percentage dark chocolate composition. As a result, some high cocoa dark chocolate products contain as much as 12 grams of saturated fat per serving.

Our invention successfully addresses the problems associated with relatively high cocoa % chocolate compositions in terms of taste and texture and does so while improving antioxidant delivery in the case of our standardized dark chocolate compositions and in the non-standardized dark chocolate compositions can significantly reduce saturated fat levels and in certain embodiments of the invention can significantly improve the balance of saturated, monounsaturated and polyunsaturated fats. With the use of certain edible oils such as walnut, chia seed, and canola the polyunsaturated fats especially Omega 3 ALA's or alpha-linolenic fats can be added to a non-standardized high cocoa dark chocolate composition that are absent in the normal structure of high cocoa dark chocolate.

Specifically our invention provides for a non-standardized high cocoa percentage dark chocolate composition with the following characteristics; improved taste, improved texture, improved melt, creamier taste, reduced bitterness, lower saturated fat, and a synergistic higher antioxidant content blend. In another embodiment our invention provides for a standardized high cocoa percentage dark chocolate composition with the following characteristics; improved taste, improved texture, improved melt, creamier taste, reduced bitterness and a synergistic higher antioxidant content blend.

Through years of research and development we have created compositions contained within this invention which address taste and texture and high saturated fat content problems identified above with novel combinations of ingredients and blending methods which improve the health characteristics of finished compositions. A non-standardized and standardized high cocoa dark chocolate composition can be made that meets and exceeds consumer's expectations for taste, texture, melt, creaminess, and reduction of bitterness without the need to process cocoa solids with alkali, without the need to add high levels of cocoa seed butter and without adding milk fat in the formulas. These compositions enhance the inherent health characteristics of the non-standardized and standardized high cocoa dark chocolate without damaging antioxidants.

1. Description of Related Art by Product Type

Milk Chocolate

The most popular chocolate or chocolate candy consumed in the United States is in the form of sweet chocolate or milk chocolate. Milk chocolate is a confection which contains nonfat milk solids, milk fat, chocolate liquor, a nutritive carbohydrate sweetener, cocoa butter and may include other optional ingredients such as emulsifiers and flavorings and other additives. Milk chocolate contains from 7% to up to 20% milk fat and sugar is the first ingredient for all brands of milk chocolate. This high sugar content and milk fat in milk chocolate are proven to increase the risk of cardiovascular disease, coronary heart disease, and diabetes. 80% of the chocolate purchased in the US is milk chocolate and globally milk chocolate also dominates the market place. Milk chocolate and sweet chocolate contribute an enormous amount of unhealthy saturated fat and sugar to US consumer's dietary intake.

Most consumers dislike the bitterness and aftertaste of dark chocolate and prefer the rich and creamy taste, texture, and melt of milk chocolate. Compositions within our invention can create a non-standardized and standardized high cocoa dark chocolate with taste and texture characteristics similar to milk chocolate: i.e. with creamy taste, better texture, improved melt and which significantly removes the bitterness that many consumer's dislike in high percentage cocoa dark chocolate. Certain embodiments of our invention have the potential to switch consumers from milk chocolate to a healthier dark chocolate product, based on the taste profile for our dark chocolate that is close to classic milk chocolate in terms of rich and creamy taste, texture, and melt.

This opportunity to convert current consumers of milk chocolate to a dark chocolate or dark chocolate compositions could contribute to improvements of health problems such as cardiovascular disease, diabetes, and other diseases caused by consumption of high levels of saturated fat, milk fat and sugar as found in most current milk chocolate compositions.

Sweet Chocolate

Sweet chocolate differs from milk chocolate in that it requires more chocolate liquor as a percent of total composition and limits the amount of milk solids as a percent of total composition. While sweet chocolate has less milk solids than milk chocolate, it still is extremely high in sugar and has high saturated fat content. Most brands of sweet chocolate also contain substantial amounts of milk fat that has negative health characteristics.

Semi-Sweet Chocolate and Dark Chocolate

Semisweet chocolate requires at least 35% by weight chocolate liquor and is otherwise similar in definition to sweet chocolate. Semisweet chocolate and bittersweet chocolate are commonly known as “dark chocolate” and include the high cocoa % dark chocolates. These “dark chocolates” generally contain only chocolate liquor, a nutritive carbohydrate sweetener, cocoa butter, and an emulsifier like lecithin. Many of the top brands of dark chocolate globally also add milk fat to the products to try to improve the taste, texture, and melt, and to help cover bitterness. As the chocolate liquor increases within the dark chocolate the saturated fat content is also increased in these compositions to offset bitterness and these high cocoa dark chocolates can have saturated fat contents as high as 65% of the total fat content and 12 grams of saturated fat per serving. The high level of chocolate liquor in high cocoa dark chocolate also makes it bitter. Many companies use chocolate liquor that has been dutched or processed with alkali to reduce the bitterness and mellow the aftertaste of the chocolate. This process of processing the cocoa solids with alkali can reduce beneficial antioxidants by 40% to up to 90%. So while the bitterness is reduced and aftertaste is mellowed by the inclusion of dutched cocoa solids, the consumer loses the benefits of the healthy antioxidants that cocoa solids would otherwise contribute to high cocoa dark chocolate.

Non-Standardized Chocolates

Chocolate used in foods in the United States is subject to a standard of identity established by the U.S. Food and Drug Administration (FDA) under the Federal Food, Drug and Cosmetic Act. The U.S. definitions and standards for the various types of chocolate are well established. Non-standardized chocolates are those chocolates which have compositions which fall outside the specified ranges of the standardized chocolates. Our invention can create either a non-standardized high cocoa dark chocolate or a standardized high cocoa dark chocolate composition that has substantially improved health characteristics, higher antioxidants, improved taste, texture, and melt, creamier taste and reduction of bitterness while within certain embodiments of the invention create non-standardized high cocoa dark chocolate compositions that have lower saturated fat and better balance of saturated, monounsaturated, and polyunsaturated fats. Within certain additional embodiments of our invention we can add beneficial essential fatty acids Omega 6 and Omega 3 that are essentially devoid in current high cocoa dark chocolate current structure.

Confections and Coatings

As a confection, chocolate can take the form of solid pieces of chocolate, such as bars or novelty shapes, and can also be incorporated as a component of other, more complex confections where chocolate is combined with and or is used as a coating for other foods such as caramel, nougat, fruit pieces, nuts, wafers or the like. Other complex confections result from surrounding with chocolate soft inclusions such as cordial cherries or peanut butter. Other complex confections result from coating ice cream or other frozen or refrigerated desserts with chocolate. Generally chocolate used to coat or surround foods must be more fluid than chocolates used for plain chocolate solid bars or novelty shapes.

The process of coating chocolate onto a food is known as enrobing. Enrobing is accomplished when the chocolate is in a fluid state and a proper viscosity must be maintained in order to produce a satisfactory coated product. Chocolate can also be molded. By molding, it is meant that chocolate, either plain or mixed with nuts, raisins, crisped rice and the like is deposited in molds, allowed to cool and hardened into solid pieces and then removed from the mould. Chocolate molded into plain chocolate pieces generally can be somewhat more viscous than coating chocolates since the chocolate can be vibrated into a mould over a longer period of time than allowed in enrobing. However, chocolate molded with food inclusions generally must be as fluid as coating chocolates.

Terada et al. in U.S. Pat. No. 4,637,937 disclose, inter alia, a chocolate emulsion comprising 5 to 35% oil, 3-30% chocolate, 10-30% sugar, 2-6% defatted milk solids, 0.05-3% stabilizer and solid content of 40%-60%. Therefore, the moisture content of the product of Terada et al is 60%-40%, respectively, which is quite high. Thus, the confections of Terada, et al. produce a chocolate emulsion having a high water activity and thus are not suitable for storing for a prolonged period of time.

U.S. Pat. No. 3,867,560 to Menzi et al. discloses a confectionery comprising 35-60% carbohydrate, 1-45% proteins which are soluble at pH 6.2-7.5, 12-20% of a gelling protein or gelling carbohydrate and 4-24% by weight water. The product formed there from is a paste. The amount of hydrocolloid used is quite large as it is used for the purpose of thermally setting the paste. Confections produced by Menzi et al. do not produce a homogenous non-flowing solid which can be made into an enrobable confectionery product, a goal of the present invention.

Low Fat vs Balanced Fats

Much work has been done to create low fat or reduced fat standardized chocolate or non-standardized chocolate compositions. U.S. Pat. No. 5,464,649 to St. John, et. al.

discloses a lowfat chocolate confection that can be made with as low as 25% total fat having flow properties suitable for molding, extruding or enrobing operations. It was initially thought that low fat was the most important aspect of our diet that contributes to improved health for the consumer.

In the 1980's the FDA established food claims guidelines including ones that were based on a “low fat” diet being important to reduce the risk of coronary heart disease and to improve consumer's health. Through continued scientific study it has been found that it is not the amount of fat in the diet per se that is the critical aspect for reducing health related issues like; coronary heart disease, diabetes, obesity, and other health issues, but rather the types of fats and the balance of those fats which are included in foods

As food producers responded to the FDA guidelines of the 1980s many “low fat” foods including confectionery foods were introduced. The 2005 USDA Dietary Guidelines; however, now suggests under its fat recommendations that consumers should reduce the amount of saturated fat in the diet and replace it with unsaturated fatty acids like monounsaturated and polyunsaturated fats. Consensus in the medical community, based on clinical research and food studies, is that increased levels of monounsaturated and polyunsaturated fats in the diet would help in the prevention of cardiovascular disease and coronary heart disease related problems.

The link below discusses the Harvard School of Public Health study that was the largest food study ever created to examine how certain fats affect consumer's long term health. The conclusion is that consumers need to get more of the “good unsaturated fats” (unsaturated fats including monounsaturated and polyunsaturated fats) and less of the saturated fats in their diets. The current invention creates non-standardized high cocoa dark chocolate compositions that have new structures to improve the taste, texture, melt, and creaminess while significantly reducing bitterness and reducing the saturated fat content (up to 75% less saturated fat than regular high cocoa dark chocolate) which increases the beneficial monounsaturated and polyunsaturated fat content. Certain embodiments of this invention can add the essential fatty acids Omega 6 and Omega 3 ALA's which are currently found in extremely small amounts in regular dark chocolate. Omega 3 ALA's, which are among the most healthy polyunsaturated fats are found in very small amounts naturally in high cocoa dark chocolate, can be included within compositions of this invention.

This report is based on the largest study ever undertaken on the effect of reducing saturated fats and replacing them with unsaturated fats including monounsaturated and polyunsaturated fats. The study concluded that many of the major health issues facing consumers today can be directly attributed to the consumption of high levels of saturated fat, partially hydrogenated, fully hydrogenated, and trans fats. The study examined the effect of replacing such saturated fats with healthier monounsaturated and polyunsaturated fats in the diet and concluded that this had a significant effect on reducing the risks of developing chronic health conditions including cardiovascular disease and coronary heart disease.

Mars, Incorporated launched a high cocoa dark chocolate product line in 2007 called Cocoa Vie that was based on its high antioxidant cocoa and that had plant sterols added for additional cardiovascular health. The marketing platform for the Cocoa Vie product line was “Heart Healthy”. The FDA took issue with the labeling of the product as heart healthy because of its high level of saturated fat. Mars, Incorporated fought the FDA on the issue that high cocoa dark chocolate is heart healthy and that the additives enhanced the product lines health characteristics even more than regular high cocoa dark chocolate. The Cocoa Vie product line suffered from poor taste compared to Mars, Incorporated's Dove high cocoa dark chocolate and the high saturated fat content plagued the product line's Heart Healthy platform. Mars, Incorporated finally pulled the Cocoa Vie line from the market place and currently only sells it over the internet. Embodiments within this current invention can create high cocoa dark chocolate composition formulas with up to 75% less saturated fat than regular high cocoa dark chocolate with improved taste, texture, melt, and creaminess with substantially less bitterness compared to standard regular high cocoa dark chocolate products in the market place while improving the balance of saturated, monounsaturated and polyunsaturated fats and in some embodiments of the current invention Omega 6 and Omega 3 ALA's the healthiest of the polyunsaturated fats can be incorporated.

A consumer study (see Exhibit 1) was done comparing a Lindt 70% Cocoa Dark Chocolate product made by the global leader in the category versus our non-standardized 70% Cocoa Dark Chocolate composition made within components from claim 32 above that has 25% less saturated fat compared to the Lindt product. Our non-standardized 70% Cocoa Dark Chocolate composition scored substantially higher on all important consumer driven attributes for chocolate including; taste, texture, melt, creaminess, bitterness, aftertaste, hardness, etc. Our non-standardized 70% Cocoa Dark Chocolate composition was preferred 93% of the time versus the Lindt 70% Cocoa Dark Chocolate. The consumer study clearly shows that our invention can improve the health characteristics by lowering saturated fat at the same time creating an improved taste, texture, melt, and creaminess with reduced bitterness non-standardized high cocoa dark chocolate composition while improving the balance of fats and in some cases adding Omega 6 and Omega 3 essential fatty acids to the compositions.

### SUMMARY OF THE INVENTION

It is, therefore, an object of this invention to provide an improved taste, improved texture, improved melt, creamier and substantially less bitterness non-standardized and standardized high cocoa dark chocolate with improved health characteristics. This high cocoa dark chocolate can be made as a non-standardized dark chocolate or as a standardized dark chocolate composition that uses high cocoa dark chocolate as the base for the composition. It is another object of the present invention to create non-standardized and standardized high cocoa dark chocolate compositions that improve the taste, texture, melt, and significantly reduce the bitterness without the necessity of adding milk solids or milk fat or processing the cocoa with alkali, as is the case with many current produced high cocoa dark chocolate products. It is another object of the present invention to improve the health characteristics of high cocoa dark chocolate by creating non-standardized high cocoa dark chocolate compositions that can have lower saturated fat content up to 75% less saturated fat versus regular high cocoa dark chocolate and that has improved taste, texture, melt, creaminess and that has significantly less bitterness than regular high cocoa dark chocolate with an improved balance of saturated, monounsaturated and polyunsaturated fats and in certain embodiments add the essential fatty acids Omega 6 and Omega 3 within the compositions.

It is another object of the present invention to create compositions of non-standardized and standardized high cocoa dark chocolate that add a synergistic high antioxidant content blend of ingredients that includes; virgin coconut oil, vanilla powder, blackberry powder, and acai berry extract that creates a flavor profile that improves the taste, texture, melt, creaminess, and significantly reduces the bitterness of the non-standardized and standardized high cocoa dark chocolate compositions versus standardized high cocoa dark chocolate formulas and which enhance the nutritional health benefits of the compositions.

Most major brands of high cocoa dark chocolate use the current methods available to try to create a more palatable high cocoa dark chocolate including; a. adding milk or milk fat to the product to mask the bitterness and to try and improve the taste, texture, and melt of the compositions, b. using cocoa solids processed with alkali to reduce the bitterness and make the aftertaste of the product more mellow, and c. adding high levels of cocoa butter to the product called couvertures to improve the taste profile of the product and lessen the bitterness that the cocoa solids portion of the high cocoa dark chocolate creates in the product. Hershey's Extra Dark is an example of a high cocoa dark chocolate that adds significant amounts of milk and milk fat to its product in order to improve the taste, texture, and melt of the product. Dove Silky Smooth Dark chocolate is an example of a high cocoa dark chocolate that uses cocoa processed with alkali and also has addition of milk fat. Dove's 71% Cocoa Dark Chocolate has milk fat added to the chocolate to try and mask the bitterness and improve the taste, texture, and melt of the product. Lindt's 70% Cocoa Dark Chocolate is an example of a couverture type product that has a high level of cocoa seed butter in the product to help its taste profile. Hershey's Extra Dark 60% Cocoa complete line has milk and milk fat added to the high cocoa dark chocolate products to try and mask bitterness and improve the taste, texture, and melt of the products. Hershey's Special Dark uses milk fat and cocoa processed with alkali to try and mask the bitterness and improve the taste, texture, and melt of the product.

Consumers believe that when they buy a high cocoa dark chocolate bar that it is high in antioxidants and that it has health benefits that include some cardiovascular benefits. Global marketers aren't required to list when they add milk or milk fat to high cocoa dark chocolate or when the cocoa is processed with alkali or the percentage of cocoa seed butter used in the product. The majority of consumers don't know when the high cocoa dark chocolate has been modified with milk fat or processed with alkali, or has high levels of cocoa butter added to the product because it is only on the ingredient label and not on the front of the packaging. The cocoa seed butter content isn't even listed on the ingredient label and only has to be listed as an ingredient of the product.

A recent survey done by Barry Callebaut the world's largest supplier of high cocoa dark chocolate shows that 70% of consumers responded that 70% cocoa dark chocolate was healthy and that it was good for your heart. The link to this study is below. Major global research recently has confirmed that the antioxidants in dark chocolate have a wide group of health benefits. Many top medical authorities including Cleveland Clinic say that dark chocolate has health benefits.

The problem is that the consumer is being misled by a majority of the high cocoa dark chocolate products sold in the market place today. Consumers are unknowingly eating high cocoa dark chocolate for health benefits that has had milk and milk fat added to the products that reduces the health benefits of the products. Consumer's are also eating high cocoa dark chocolate that they believe has high levels of beneficial antioxidants when the high cocoa dark chocolate products have been processed with alkali that damages up to 90% of the antioxidant content. Valor a top European brand and producer of a 70% Cocoa Dark Chocolate product processes the cocoa solids with alkali and nowhere on the package except the ingredient label does it explain the processing with alkali.

Through years of experimentation and research and development our invention produces compositions of non-standardized and standardized high cocoa dark chocolate that can give the consumer great taste while using novel technology that actually improves the health characteristics of the high cocoa dark chocolate while also improving the taste, texture, melt, creaminess and significantly reducing the bitterness without the necessity of using the current methods that damage the health characteristics of the high cocoa dark chocolate products. Through years of research we have been able to use completely new methods to accomplish a superior tasting high cocoa dark chocolate product without the necessity of adding milk fat or processing the cocoa solids with alkali or having the need to add high levels of cocoa seed butter in the couverture products or high cocoa seed butter products.

It is another object of the present invention to provide a non-standardized or standardized high cocoa dark chocolate that can claim a nutritional structure that the medical community including the FDA would concede is heart healthy. Within certain embodiments of this invention we can create a non-standardized high cocoa dark chocolate compositions with superior taste that has up to 75% less saturated fat while actually increasing the antioxidant content of the product without the necessity of adding milk fat or using cocoa solids processed with alkali and actually reduces the cocoa seed butter that normally would be in the product. These compositions can have substantially better balance between the saturated, monounsaturated and polyunsaturated fats and in certain embodiments can have higher levels of the beneficial essential fatty acids Omega 6 linoleic and Omega 3 ALA's alpa-linolenic in the non-standardized high cocoa dark chocolate compositions. Based on this completely new structure of a non-standardized high cocoa dark chocolate composition we believe that a heart healthy claim is within reach for our compositions. Below is a link to a site that shows the FDA approval for allowing Frito Lay to market snacks that have substantial amounts of saturated fats replaced with unsaturated fats. Science links the replacement of saturated fats with unsaturated fats as a way to reduce the risk of heart disease and other chronic health problems that face our society.

High cocoa dark chocolate while having proven health benefits from its antioxidant content is very high in saturated fat because of the cocoa seed butter content and a serving of most 70% cocoa dark chocolate products delivers 10 to 12 grams of saturated fat per serving. Compositions within our invention can produce a superior tasting non-standardized 70% cocoa dark chocolate composition with up to 75% less saturated fat while maintaining and actually improving the taste, texture, melt, and reducing the bitterness of the product. The ability to reduce the saturated fat content while actually improving the health characteristics of the non-standardized high cocoa dark chocolate compositions can have a profound effect on consumer's overall health. Millions of pounds of saturated fat can be removed from the diets of global consumers with certain embodiments of our invention that reduce saturated fat content and increase good monounsaturated and polyunsaturated fat content at the same time as delivering high antioxidant content.

These and other objects are achieved using novel confectionery non-standardized high cocoa dark chocolate compositions or using standardized high cocoa dark chocolate compositions. The compositions contain confectionery ingredients that deliver compositions with improved taste characteristics as well as improved health characteristics. The compositions can be available to the consumer in convenient, chocolate squares, chocolate tablet bars, other molded confectionery shapes, or other confectionery uses including enrobing, coating, or mixed confectionery products where other ingredients are added into the compositions.

In one embodiment of the invention a non-standardized high cocoa dark chocolate composition has the following characteristics that can lower saturated fat content up to 75% compared to regular standardized high cocoa dark chocolate with improved taste, texture, melt, and reduced bitterness while improving the balance of the fats within the product and adding beneficial essential fatty acids Omega 6 and Omega 3 ALA's.

Such a non-standardized high cocoa dark chocolate composition comprises:
a. 40% to 65% a high cocoa dark chocolate component
b. 0% to 30% a chocolate liquor component
c. 0.001% to 5% virgin coconut oil component
d. 0.001% to 5% vanilla powder component
e. 0% to 4% blackberry powder component
f. 0% to 1% acai berry extract component
g. 10% to 15% edible oil component (blend of canola, soybean, and sunflower)
h. 10% to 20% 100% cocoa powder component
i. 10% to 20% confectionery sugar component

An embodiment of the present invention is a composition comprising: a. 40% to 65% a high cocoa dark chocolate component, by weight of said composition; and b. 0% to 30% chocolate liquor component, by weight of said composition; c. 0.001% to 5% virgin coconut oil component, by weight of said composition.

A further embodiment of the present invention is a composition comprising: a. 40% to 65% a high cocoa dark chocolate component, by weight of said composition; and b. 0% to 30% chocolate liquor component by weight of said composition; c. 0.001% to 5% virgin coconut oil component, by weight of said composition; and d. 0.001% to 5% vanilla powder component, by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition;, and e. 0% to 4% blackberry powder component, by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition; e. 0% to 4% blackberry powder component, by weight of said composition; and f. 0% to 1% Acai Berry extract component, by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition; e. 0% to 4% blackberry powder component, by weight of said composition; f. 0% to 1% Acai Berry extract component, by weight of said composition; and g. 10% to 15% edible oil component (blend of canola, soybean, and sunflower), by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition; e. 0% to 4% blackberry powder component, by weight of said composition; f. 0% to 1% Acai Berry extract component, by weight of said composition; g. 10% to 15% edible oil component (blend of canola, soybean, and sunflower), by weight of said composition; and h. 10% to 20% a 100% cocoa component, by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition; e. 0% to 4% blackberry powder component, by weight of said composition; f. 0% to 1% Acai Berry extract component, by weight of said composition; g. 10% to 15% edible oil component (blend of canola, soybean, and sunflower), by weight of said composition; and h. 10% to 20% a 100% cocoa component, by weight of said composition; i. 10% to 20% a confectionery sugar component, by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition; e. 0% to 4% blackberry powder component, by weight of said composition; f. 0% to 1% Acai Berry extract component, by weight of said composition; g. 10% to 15% edible oil component (blend of canola, soybean, and sunflower), by weight of said composition; and h. 10% to 20% a 100% cocoa component, by weight of said composition; i. 10% to 20% a confectionery sugar component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition.

A further embodiment of the present invention is a composition comprising: a. 40% to 65% a high cocoa dark chocolate component; b. 0% to 30% chocolate liquor component, by weight of said composition; c. 0.001% to 5% virgin coconut oil component, by weight of said composition; d. 0.001% to 5% vanilla powder component, by weight of said composition; e. 0% to 4% blackberry powder component, by weight of said composition; f. 0% to 1% Acai Berry extract component, by weight of said composition; g. 10% to 15% edible oil component (blend of canola, soybean, and sunflower), by weight of said composition; and h. 10% to 20% a 100% cocoa component, by weight of said composition; i. 10% to 20% a confectionery sugar component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component of a preservative component and mixing until the above mixture becomes homogeneous with the additional listed components.

Additionally, an embodiment of the present invention is a composition comprising the steps of: a. melting the standardized high cocoa dark chocolate and chocolate liquor component if necessary and tempering it in a mixing vessel or then putting it into a mixing vessel; b. adding the vanilla powder component to the mixing vessel; c. adding blackberry powder if necessary in the mixing vessel; d. adding the Acai berry extract if necessary component to the mixing vessel and mix until a homogeneous mixture. In a separate mixing vessel; a. add the virgin coconut oil component to the mixing vessel; b. add the edible oil component to the mixing vessel; c. add the confectionery sugar component and heat to a temperature that completely dissolves the confectionery sugar and blend until homogeneous; d. then add the 100% cocoa component to the mixing vessel and mix until said group of ingredients are completely blended into a homogeneous mixture. Add the contents of the second mixing vessel into the first mixing vessel reduced to 92 degrees Fahrenheit and mix both contents until homogeneous; thus creating said double blended non-standardized high cocoa dark chocolate composition.

Additionally, an embodiment of the present invention is a composition comprising the steps of: a. melting the standardized high cocoa dark chocolate and chocolate liquor if necessary and tempering it in a mixing vessel or then putting it into a mixing vessel that can keep the temperature at 92 degrees Fahrenheit or higher; b. adding the vanilla powder component to the mixing vessel; c. adding blackberry powder if necessary in the mixing vessel; d. adding the Acai berry extract component if necessary to the mixing vessel and mix until a homogeneous mixture. In a separate mixing vessel at 92 degrees Fahrenheit or above; a. add the virgin coconut oil component to the mixing vessel; b. add the edible oil component to the mixing vessel; c. add the confectionery sugar component to the mixing vessel and heat until completely dissolved and blend until completely homogeneous; d. then add the 100% cocoa component to the mixing vessel and mix until said group of ingredients are completely blended into a homogeneous mixture. Add the contents of the second mixing vessel reduced to 92 degrees Fahrenheit into the first mixing vessel and mix both contents keeping the temperature at least at 92 degrees Fahrenheit in order to keep the composition properly tempered until homogeneous; thus creating said double blended non-standardized high cocoa dark chocolate composition. While the above method utilizes an already made standardized dark chocolate and chocolate liquor as ingredients in the above described method of creation, the method of creating the non-standardized dark chocolate could be altered to include making the composition all at once at the time of initial product creation. In this case all of the above ingredients would be added together in the process to create the non-standardized dark chocolate composition and would avoid the necessity of double blending. This method would lose some of the benefit of improved creaminess, but would still have the bulk of the above listed advantages including; an improved health characteristic, synergistic higher antioxidant content blend, reduced bitterness, improved taste, improved melt, improved texture, lower saturated fat content composition.

Add to the above blended non-standardized high cocoa dark chocolate composition 0% or greater a supplement component and a preservative component.

In a second embodiment of the present invention a standardized high cocoa dark chocolate composition has the following characteristics that provide additional antioxidant components creating a high cocoa dark chocolate with improved taste, texture, melt, creaminess and significantly less bitterness to almost no bitterness at all in the certain formulas.

Such a composition comprises:
a. 80% to 95% high cocoa dark chocolate component
b. 0% to 30% chocolate liquor component
c. 3% to 5% vanilla powder component
d. 3% to 4% virgin coconut oil component
e. 0% to 3% blackberry powder component
f. 0% to 0.005% Acai berry extract component

An embodiment of the present invention is a composition comprising: a. 80% to 95% a high cocoa dark chocolate component, by weight of said composition; b. 0% to 30% chocolate liquor component, by weight of said composition; and c. 3% to 5% vanilla powder component, by weight of said composition.

A further embodiment of the present invention is a composition comprising: a. 80% to 95% a high cocoa dark chocolate component, by weight of said composition; b. 0% to 30% chocolate liquor component, by weight of said composition; c. 3% to 5% vanilla powder component, by weight of said component; and d. 3% to 4% virgin coconut oil component, by weight of said composition.

A further embodiment of the present invention is a composition comprising: a. 80% to 95% a high cocoa dark chocolate component, by weight of said composition; b. 0% to 30% chocolate liquor component, by weight of said composition; c. 3% to 5% vanilla powder component, by weight of said component; d. 3% to 4% virgin coconut oil component, by weight of said composition; and e. 0% to 3% blackberry powder component, by weight of said composition.

A further embodiment of the present invention is a composition comprising: a. 80% to 95% a high cocoa dark chocolate component, by weight of said composition; b. 0% to 30% chocolate liquor component, by weight of said composition; c. 3% to 5% vanilla powder component, by weight of said component; d. 3% to 4% virgin coconut oil component, by weight of said composition; e. 0% to 3% blackberry powder component, by weight of said composition; and f. 0% to 0.005% Acai Berry extract component, by weight of said composition.

A further embodiment of the present invention is a composition comprising: a. 80% to 95% a high cocoa dark chocolate component, by weight of said composition; b. 0% to 30% chocolate liquor component, by weight of said composition; c. 3% to 5% vanilla powder component, by weight of said component; d. 3% to 4% virgin coconut oil component, by weight of said composition; e. 0% to 3% blackberry powder component, by weight of said composition; f. 0% to 0.005% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition.

A further embodiment of the present invention is a composition comprising: a. 80% to 95% a high cocoa dark chocolate component, by weight of said composition; b. 0% to 30% chocolate liquor component, by weight of said composition; c. 3% to 5% vanilla powder component, by weight of said component; d. 3% to 4% virgin coconut oil component, by weight of said composition; e. 0% to 3% blackberry powder component, by weight of said composition; f. 0% to 0.005% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional preservative component.

Additionally, an embodiment of the present invention is a composition comprising the steps of: a. melting the standardized high cocoa dark chocolate and tempering it in a mixing vessel or then putting it into a mixing vessel that can keep the temperature at 92 degrees Fahrenheit or higher; b. add the 0% to 30% chocolate liquor component, by weight of said composition; and c. add the 3% to 5% vanilla powder component, by weight of said component; d. add the 3% to 4% virgin coconut oil component, by weight of said composition; e. add the 0% to 3% blackberry powder component, by weight of said composition; f. add the 0% to 0.005% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and add an additional component selected from the group consisting of a flavor component, a color component, a preservative component. The complete group of ingredients would be mixed until completely homogeneous. While the above method utilizes an already made standardized dark chocolate and chocolate liquor as ingredients in the above described method of creation, the method of creating the standardized dark chocolate could be altered to include making the composition all at once at the time of initial dark chocolate product creation. In this case all of the above ingredients would be added together in the process to create the standardized dark chocolate composition from the bench up and would avoid the necessity of double blending.

### BRIEF DESCRIPTION OF THE DRAWINGS

FIG. 1

FIG. 2

FIG. 3

FIG. 4

FIG. 5

FIG. 6

### DETAILED DESCRIPTION OF THE DRAWINGS

### Definitions

All percentages and ratios are calculated by weight unless otherwise indicated. All percentages and ratios are calculated based on the total final composition unless otherwise indicated.

Referenced herein may be trade names for components including various ingredients utilized in the present invention. The inventors herein do not intend to be limited by materials under a given trade name. Equivalent materials (e.g., those obtained from a different source under a different name or reference number) to those referenced by trade name may be substituted and utilized in the description.

As used herein “fiber” generally means material derived from plant cell walls and which is not digestible by human digestive enzymes, including soluble fiber and insoluble fiber. The fiber component can be naturally derived or synthetic. A portion of the fiber component can be non-starch polysaccharides, including soluble and non soluble fiber. As used herein “soluble fiber” means plant gums and oligosaccharides, or modified gums, modified celluloses, non-starch polysaccharides that are soluble in water, some of which can form viscous gels.

### The Invention

Generally, as known in prior art many patents have been granted for creating low fat or reduced fat chocolate products. Our current invention focused on the current aspects of high cocoa dark chocolate that can improve its health characteristics and expand the potential consumer market that would eat a high cocoa dark chocolate if it had the characteristics of milk chocolate in terms of taste, texture, creaminess, and melt. Many companies have tried just adding healthy ingredients to high cocoa dark chocolate with the belief that the consumer will buy them just because of the healthy ingredients. The consumer has shown that chocolate and even high cocoa dark chocolate is primarily bought because of taste. Mars Incorporated has created several product lines recently including; Cocoa Vie, Dove Vitalize, and Dove Beautiful. These were examples of trying to create functional food type of chocolate offerings that were supposed to give the consumer a specific health benefit. Cocoa Vie was target market positioned to be Heart Healthy. The problem was that all three of the above brands didn't taste as good as regular Dove chocolate versions. All three of the products have now been pulled from major retail marketing and were unsuccessful.

The uniqueness of the current invention is that we can improve the health characteristics of high cocoa dark chocolate at the same time improving the taste, texture, melt, and reducing the bitterness. The ability of our compositions to actually taste better than non-standardized or standard chocolate compositions available in the marketplace today, is a critical accomplishment of our invention and novel technology.

Another important aspect of this invention is that within certain embodiments we can create non-standardized high cocoa dark chocolate compositions that have nutritional contents that allow for the present invention to be more widely physician recommended. Many medical establishments including Michigan Integrative Medicine and Cleveland Clinic have stated that high cocoa dark chocolate with no milk fat and not processed with alkali has health benefits in a daily diet. A vast majority of medical professionals including Harvard Medical School Public Health states that high cocoa dark chocolate is too high in saturated fat to be an everyday healthy food in the diet. In certain combinations of our invention we can use certain ratio of ingredients within our non-standardized high cocoa dark chocolate that lower the saturated fat content by 75% while actually improving the health characteristics and the taste, texture, melt, and reduce the bitterness of the product while improving the balance of the saturated, monounsaturated, and polyunsaturated fats and in certain embodiments of our invention add more of the essential fatty acids Omega 6 linoleic and Omega 3 ALA's alpha-linolenic to the compositions. The polyunsaturated fats Omega 6 and Omega 3 have proven health benefits compared to saturated fats in the diet and in certain embodiments of our invention we can replace the saturated fats within the high cocoa dark chocolate with these healthier fats.

Standard 70% Cocoa Dark Chocolate has a serving size of 40 grams and would have a total fat content of 17 grams with 10 grams of saturated fat, 6.5 grams of monounsaturated fat, and 0.5 grams of polyunsaturated fat. Even though high cocoa Dark Chocolate has proven health benefits to the circulatory system and is high in antioxidants many physicians wouldn't prescribe eating it regularly due to its high saturated fat content. One example of a non-standardized 70% high cocoa dark chocolate composition created with this invention can have a nutritional structure of a 40 gram serving size that has 16 grams of total fat with 6 grams of saturated fat, 8 grams of monounsaturated fat, and 2 grams of polyunsaturated fat. In certain embodiments of this invention we can move the polyunsaturated fat content even higher and displace some of the monounsaturated fats to polyunsaturated fats to improve the health characteristics of the compositions even more. The present invention shifts the nutritional profile of the compositions to a range which can be expected to be widely physician recommended as a food for an everyday healthy daily diet.

Through experimentation and extensive research and development it was discovered that an embodiment of the present invention comprises a composition having a. 40% to 65% a high cocoa dark chocolate component, by weight of said composition; b. 0% to 30% a chocolate liquor component, by weight of said composition; c. a 0.007% to 2% virgin coconut oil component, by weight of said composition; d. 2% to 3% vanilla powder component, by weight of said component; e. 0% to 1.5% blackberry powder component, by weight of said composition; e. 0% to 0.005% Acai Berry extract component, by weight of said composition; f. 10% to 15% edible oil component (blend of canola, soybean, and sunflower), by weight of said composition; g. 10% to 20% a 100% cocoa component, by weight of said composition; h. 10% to 20% a confectionery sugar component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component of a preservative component.

### High Cocoa Dark Chocolate Component

The composition of the present invention comprises at least about 40% of a high cocoa dark chocolate component, alternately 40% to 45%, alternately 45% to 50%, alternatively 50% to 55%, alternatively 55% to 60%, alternatively 60% to 65% of a high cocoa dark chocolate component, by weight, of said composition.

The preferred embodiment of the invention would use a high cocoa dark chocolate component that has no milk or milk fat added to the high cocoa dark chocolate used. The high cocoa dark chocolate component must not have been processed with alkali. Finally, in the preferred embodiment of the invention the high cocoa dark chocolate component would be all natural and would have no artificial flavors. An example of a high cocoa dark chocolate product with these attributes is Tulsa Dark sold by Barry Callebaut a global raw material supplier. While high cocoa dark chocolate that has milk or milk fat added to it, is processed with alkali, and that has artificial flavors added to it could be used within the invention it would be counter intuitive to the concept of producing a high cocoa dark chocolate with improved health characteristics as the inclusion of milk fat or alkali processed cocoa would lower the health characteristics of the high cocoa dark chocolate.

### Chocolate Liquor Component

The composition of the present invention comprises at least about 0% to 30%, alternatively 25% to 30%, alternatively, 20% to 25%, alternatively, 15% to 20%, alternatively 10% to 15%, alternatively 5% to 10%, alternatively 0% to 5%, by weight, of said composition. The preferred embodiment of the invention would use a natural, no milk or milk fat, non-processed with alkali chocolate liquor. An example of such chocolate liquor would be SR22 sold by Barry Callebaut that has no artificial flavors, milk or milk fat, and isn't processed with alkali. While chocolate liquor that has milk or milk fat added to it, is processed with alkali, and that has artificial flavors added to it could be used within the invention it would be counter intuitive to the concept of producing a high cocoa dark chocolate with improved health characteristics as the inclusion of milk fat or alkali processed cocoa would lower the health characteristics of the high cocoa dark chocolate. The chocolate liquor in this invention can be used to maintain a particular cocoa level by adding the chocolate liquor back into the formula based on the addition of certain materials within the present invention.

### Virgin Coconut Oil Component

The composition of the present invention comprises 0.007% to 2% of a virgin coconut oil component. This virgin coconut oil component makes up part of the flavor profile that has a synergistic effect on improving the taste, texture, melt, and reduction of bitterness in our non-standardized and standardized high cocoa dark chocolate compositions. The blend of the flavor components is a critical aspect of how the present invention accomplishes the improved taste, texture, melt and reduction in bitterness of the compositions. Therefore, it is necessary for the virgin coconut oil component to have a good flavor profile and not to have any of the flavor profile removed by processing the oil. Nature's Flavors supplies a kosher virgin coconut oil that has good flavor and works well within the present invention.

### Vanilla Powder Component

The composition of the present invention includes a vanilla powder component at 2% to 3% of said invention. This vanilla powder component makes up part of the flavor profile that has a synergistic effect on improving the taste, texture, melt, and reduction of bitterness in our non-standardized and standardized high cocoa dark chocolate compositions. The blend of flavor components is a critical aspect of how the present invention accomplishes the improved taste, texture, melt and reduction in bitterness of the compositions. Therefore, it is necessary for the vanilla powder component to have a specific flavor profile and Cook's Flavoring Company currently sells the vanilla powder that is within the flavor component of the present invention. Another vanilla powder or natural vanilla extract could be used, but it would have to have a similar taste profile and must be have the same structure as the Cook's Flavoring Company's vanilla powder.

### Blackberry Powder Component

The composition of the present invention includes a blackberry powder component at 0% to 1.5% of said invention. This blackberry powder component can make up part of the flavor profile that has a synergistic effect on improving the taste, texture, melt, and the reduction of bitterness in our non-standardized and standardized high cocoa dark chocolate compositions. The blend of flavor components is a critical aspect of how the present invention accomplishes the improved taste and reduction in bitterness of the compositions. Therefore, it is necessary for the blackberry powder component to have a specific flavor profile and Decas Botanicals supplies the current blackberry powder component. Other blackberry powder's can be substituted for the Decas Botanicals product, but the blackberry powder would need to have similar characteristics. While blackberry powder is the preferred flavor ingredient in the present invention other berry powders could be used including; raspberry, Marion blackberry, black raspberry, or other berry powders that can produce the same taste profile as the blackberry powder does with the present invention.

The blackberry powder can be used in its current milled form at 60 mesh or the blackberry powder can be milled to 120 mesh or higher that will allow the blackberry powder to blend completely into compositions without having a additional grit added to the high cocoa dark chocolate compositions.

### Acai Berry Extract Component

The composition of the present invention includes an Acai Berry Extract component at 0% to 0.005% of said invention. This Acai Berry Extract component can make up part of the flavor profile that has a synergistic effect on improving the taste, texture, and melt and reduction of bitterness in the non-standardized and standardized high cocoa dark chocolate compositions. The blend of flavor components is a critical aspect of how the present invention accomplishes the improved taste and reduction in bitterness of the compositions. Therefore, it is necessary for the Acai Berry Extract to have a specific flavor profile and Jarchem a botanical material supplier in New Jersey distributes this product. Other Acai Berry Extract products can be used, but it would be important that these Acai Berry Extract products have similar taste profiles.

### Edible Oil Component

The composition of the present invention includes an edible oil component at 10% to 15% of said invention. This edible oil component makes up part of the group of ingredients that adjust the taste, texture, and improve the melt and creaminess of the non-standardized and standardized high cocoa dark chocolate compositions. The edible oil component also improves the health characteristic of the non-standardized high cocoa dark chocolate compositions because it adds monounsaturated and polyunsaturated fats and displaces saturated fat in the non-standardized high cocoa dark chocolate. An example of an edible oil component is a blend of canola, soybean oil, and sunflower oil. Non-limiting examples of an edible oil component acceptable for the present invention need to have low saturated fat content and high unsaturated fat including monounsaturated and especially polyunsaturated oils. The edible oil component needs to have no specific flavor and needs to be basically bland or somewhat buttery in taste. The edible oils component can come from the following; canola oil, soybean oil, safflower oil, sunflower oil, sesame oil, walnut oil, olive oil, flaxseed oil, chia seed oil, almond oil, corn oil, grape seed oil, peanut oil, other nut oils, and combinations thereof. Use of certain oils within the present invention including walnut or chia seed oil especially would move the final non-standardized high cocoa dark chocolate composition towards the most balanced structure possible between saturated, monounsaturated, and polyunsaturated fats and would include excellent amounts of Omega 3 ALA's and Omega 6 essential fatty acids within the compositions.

### 100% Cocoa Powder Component

The composition of the present invention includes a 100% Cocoa component at 10% to 20% of said invention. The 100% cocoa component makes up part of the group of ingredients that adjust the taste, texture, and improve the melt and creaminess of the non-standardized high cocoa dark chocolate compositions. The 100% Cocoa component also improves the health characteristic of the invention because 100% Cocoa actually has the highest antioxidant content of all the cocoa bean parts. The 100% cocoa component also adds a creaminess aspect to the non-standardized high cocoa dark chocolate compositions and in the present invention it adds to the improved mouthfeel of the compositions. An example of a 100% cocoa component acceptable for the present invention is a Natural 100% Cocoa Powder not processed with alkali and supplied by Barry Callebaut. While this Natural 100% Cocoa is acceptable any 100% Cocoa Powder supplied from a vendor is suitable and preferred to be non-dutched or not processed with alkali. A Cocoa Powder below 100% Cocoa could also be used in place of the 100% Cocoa and would be preferred to have the above same characteristics of natural, non-alkali processed, and no artificial flavors.

### Confectionery Sugar Component

The composition of the present invention includes a confectionery sugar component at 10% to 20% of said invention. The confectionery sugar component contributes to the taste, texture, and melt characteristics of the non-standardized high cocoa dark chocolate compositions. Any suitable confectionery sugar component can be used within the invention. The only critical aspect is that the confectionery sugar must be natural and must have a fine standard milled characteristic.

The virgin coconut oil, vanilla powder, blackberry powder, Acai berry extract, edible oil, 100% cocoa powder, and confectionery sugar components together create a synergistic effect within the non-standardized high cocoa dark chocolate compositions that improves the taste, texture, melt, and creaminess, reduces bitterness and allows for a final composition that can have up to 75% less saturated fat than regular standardized high cocoa dark chocolate products. Exhibit 1 summarizes a consumer survey that compared our non-standardized 70% Cocoa Dark Chocolate composition versus the global leader in the category: Lindt's 70% Cocoa Dark Chocolate on a wide group of characteristics that consumers use to evaluate chocolate. Our non-standardized 70% Cocoa Dark Chocolate composition scored closer on all important aspects and substantially closer on many of the attributes. This can be seen on the spider graph within the Exhibit 1 attachment.

### Supplement Component

Additionally, embodiments of the compositions of the present invention can include at least about 0% or greater, by weight of the composition, a supplement component such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition of the present invention can include from about 0% to about 25%, alternatively from about 0% to about 10%, and alternatively from about 0% to about 5%, by weight of the composition, of a supplement component.

### Preservative Components

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0% to 2%, by weight of the composition a preservative component from above or mixtures thereof.

### Method of Making

Example methods of preparing compositions of the present invention can comprise steps selected from the steps of: a. melting the standardized high cocoa dark chocolate and chocolate liquor if necessary and tempering it in a mixing vessel or then putting it into a mixing vessel; b. adding the vanilla powder component to the mixing vessel; c.

adding blackberry powder if necessary in the mixing vessel; d. adding the Acai berry extract component if necessary to the mixing vessel and mix until a homogeneous mixture. In a separate mixing vessel; a. add the virgin coconut oil component to the mixing vessel; b. add the edible oil component to the mixing vessel; c. add the confectionery sugar component to the mixing vessel and heat until confectionery sugar completely dissolves and blend until homogeneous then add the 100% cocoa component to the mixing vessel and blend until homogeneous. Add the contents of the second mixing vessel reduced to 92 degrees Fahrenheit into the first mixing vessel and mix both contents until homogeneous; thus creating said double blended non-standardized high cocoa dark chocolate composition.

Additionally, an embodiment of the present invention is a composition comprising the steps of: a. melting the standardized high cocoa dark chocolate and chocolate liquor if necessary tempering it in a mixing vessel or then putting it into a mixing vessel that can keep the temperature at 92 degrees Fahrenheit or higher; b. adding the vanilla powder component to the mixing vessel; c. adding blackberry powder if necessary in the mixing vessel; d. adding the Acai berry extract component if necessary to the mixing vessel and mix until a homogeneous mixture. In a separate mixing vessel at 92 degrees Fahrenheit or above; a. add the virgin coconut oil component to the mixing vessel; b. add the edible oil component to the mixing vessel; c. add the confectionery sugar component to the mixing vessel and heat until the confectionery sugar is completely dissolved and blend until homogeneous then add the 100% cocoa component to the mixing and mix until said group of ingredients are completely blended into a homogeneous mixture. Add the contents of the second mixing vessel reduced to 92 degrees Fahrenheit into the first mixing vessel and mix both contents keeping the temperature at least at 92 degrees Fahrenheit in order to keep the composition properly tempered until homogeneous; thus creating said non-standardized high cocoa dark chocolate composition. The double blending of the present embodiment of this invention also increases the rich and creamy taste, texture, and melt of our non-standardized high cocoa dark chocolate compositions created within this invention. While the above method utilizes an already made standardized dark chocolate and chocolate liquor as ingredients in the above described method of creation, the method of creating the non-standardized dark chocolate could be altered to include making the composition all at once at the time of initial product creation. In this case all of the above ingredients would be added together in the process to create the non-standardized dark chocolate composition and would avoid the necessity of double blending. This method would lose some of the benefit of improved creaminess, but would still have the bulk of the above listed advantages including; an improved health characteristic, synergistic higher antioxidant content blend, reduced bitterness, improved taste, improved melt, improved texture, lower saturated fat content composition.

The final mixture can be made using a traditional chocolate molding line. The final compositions will be either made into molded squares or bars or other molded shapes by the traditional chocolate molding line. The squares or bars or shapes produced would be flow wrapped into foil wrappers or foiled with wrapper such as is standard for confectionery chocolate squares or bars in the industry. These packaged individual squares or bars can then be placed in secondary packaging, non-limiting examples include cartons, bags, pop boxes, or sleeves; and combinations thereof.

### EXAMPLES

The below examples are included for illustrative purposes only and are not intended to in any way limit the scope of the present invention.

### Example 1

Non-standardized Dark Chocolate Composition with 25% Less Saturated Fat Then Regular Dark Chocolate and Improved Taste, Texture, Melt, Creaminess and Substantially Less Bitterness Compared To Regular Dark Chocolate with improved balance of fats and inclusion of Omega 3 and Omega 6 essential fatty acids

At room temperature add 12.8 ounces of Tulsa Dark brand dark chocolate supplied by Barry Callebaut to a melting confectionery mixer that can also temper the chocolate. Melt and temper the 12.8 ounces of Tulsa Dark chocolate and make sure it stays at 92 degrees Fahrenheit or above. Then add 12 grams of vanilla powder to the melted chocolate. Then add 4 grams of blackberry powder to the melted chocolate. Then add 1.3 grams of Acai Berry extract to the melted chocolate. Blend these ingredients together until completely homogeneous. In a separate mixing container add 12 grams of virgin coconut oil. Add 1.6 ounces of Crisco Vegetable Oil Blend (canola oil, soybean oil, sunflower oil) and heat to 92 degrees Fahrenheit. Then add 1 oz. of confectionery sugar and heat until confectionery sugar is completely dissolved and blend until homogeneous. Then add 1 oz. of 100% Cocoa Powder and blend until homogeneous maintaining the temperature. Then add the contents of the second container that includes the virgin coconut oil, edible vegetable oil, 100% cocoa powder, and confectionery sugar to the first mixing vessel reduced to a temperature of 92 degrees Fahrenheit. Blend until the two mixtures become completely homogenous. Then add a preservative component of tocopherols supplied by Gillco at 0.001% of the total composition or 0.071 grams that promotes freshness. Blend the tocopherol into the mixture for a minimum of 10 minutes. The blended non-standardized Dark Chocolate Composition would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This same formula can be increased at same percentage levels for large scale production using standard confectionery molding processes.

### Example 2

Non-standardized 70% Cocoa Dark Chocolate Composition with 15% Less Saturated Fat Then Regular 70% Cocoa Dark Chocolate and Improved Taste, Texture, Melt, Creaminess and Substantially Less Bitterness Compared To Regular 70% Dark Chocolate with improved balance of fats and inclusion of Omega 3 and Omega 6 essential fatty acids

Add 12.8 ounces of Tulsa Dark to brand dark chocolate supplied by Barry Callebaut to a melting confectionery mixer that can also temper the chocolate. Add 3.8 ounces of SR22 Chocolate Liquor supplied by Barry Callebaut to the confectionery mixer and then melt and temper the dark chocolate and chocolate liquor. Then add 12 grams of vanilla powder to the melted and tempered chocolate and chocolate liquor. Then add 4 grams of blackberry powder supplied by Decas Botanicals. Then add 1.3 grams of Acai Berry Extract supplied by Jarchem Industries. Blend all these ingredients together until completely homogeneous. In a separate mixing container add 12 grams of virgin coconut oil. Add 1.6 ounces of Crisco Vegetable Oil Blend (canola oil, soybean oil, sunflower oil). Then add 1 oz. of confectionery sugar and heat until confectionery sugar completely dissolves and blend until homogeneous. Then add 1 oz. 100% Cocoa Powder supplied by Barry Callebaut and blend until completely homogeneous. Then add the contents of the second container that includes the coconut oil, edible vegetable oil, 100% cocoa powder, and confectionery sugar to the first mixing vessel reduced to a temperature of 92 degrees Fahrenheit. Blend until the two mixtures become completely homogenous while maintaining at least 92 degrees Fahrenheit. Then add a preservative component of tocopherols supplied by Gillco at 0.001% of the total composition or 0.071 grams that promotes freshness. Blend the tocopherol into the mixture for a minimum of 10 minutes. The blended 70% Cocoa Dark Chocolate Composition would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This same formula can be increased at same percentage levels for large scale production using standard confectionery molding processes.

Through experimentation and extensive research and development it was discovered that an embodiment of the present invention comprises a composition having the following; a. 80% to 95% a high cocoa dark chocolate component, by weight of said composition; and b. 0% to 30% chocolate liquor component, by weight of said composition; and c. 3% to 5% vanilla powder component, by weight of said component; d. 3% to 4% virgin coconut oil component, by weight of said composition; e. 0.003% to 3% blackberry powder component, by weight of said composition; f. 0.002% to 0.005% Acai Berry extract component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional preservative component.

### High Cocoa Dark Chocolate Component

The composition of the present invention comprises at least about 80% of a high cocoa dark chocolate component, alternately at least about 80% to 85%, alternately 85% to 90%, alternately 90% to 95%, of a high cocoa dark chocolate component, by weight, of said composition.

The preferred embodiment of the invention would use a high cocoa dark chocolate component that has no milk or milk fat added to the high cocoa dark chocolate used. The high cocoa dark chocolate component must not have been processed with alkali. Finally, in the preferred embodiment of the invention the high cocoa dark chocolate component would be all natural and would have no artificial flavors. An example of a high cocoa dark chocolate product with these attributes is Tulsa Dark sold by Barry Callebaut a global raw material supplier. While high cocoa dark chocolate that has milk or milk fat added to it, is processed with alkali, and that has artificial flavors added to it could be used within the invention it would be counter intuitive to the concept of producing a high cocoa dark chocolate with improved health characteristics and including such additives would lower the health characteristics of the high cocoa dark chocolate.

### Chocolate Liquor Component

The composition of the present invention comprises at least about 0% to 30%, alternatively 25% to 30%, alternatively, 20% to 25%, alternatively, 15% to 20%, alternatively 10% to 15%, alternatively 5% to 10%, alternatively 0% to 5% by weight, of said composition. The preferred embodiment of the invention would use a natural, no milk or milk fat, non-processed with alkali chocolate liquor. An example of such chocolate liquor would be SR22 sold by Barry Callebaut that has no artificial flavors, milk or milk fat, and isn't processed with alkali. The chocolate liquor in this invention can be used to maintain a particular cocoa level by adding the chocolate liquor back into the formula based on the addition of certain materials within the present invention.

### Vanilla Powder Component

The composition of the present invention includes a vanilla powder component at 3% to 5% of said invention. This vanilla powder component makes up part of the flavor profile that has a synergistic effect on the high cocoa dark chocolate compositions. The blend of flavor components is a critical aspect of how the present invention accomplishes the improved taste, texture, melt, creaminess and reduction in bitterness of the compositions. Therefore, it is necessary for the vanilla powder component to have a specific flavor profile and Cook's Flavoring Company currently sells the vanilla powder that is within the flavor component of the present invention. Another vanilla powder could be used, but it would have to have a similar taste profile and must be have the same structure as the Cook's Flavoring Company's vanilla powder.

### Virgin Coconut Oil Component

The composition of the present invention comprises 3% to 4% of a virgin coconut oil component. This virgin coconut oil component makes up part of the flavor profile that has a synergistic effect on the high cocoa dark chocolate compositions. The blend of the flavor components is a critical aspect of how the present invention accomplishes the improved taste, texture, melt, creaminess and reduction in bitterness of the compositions. Therefore, it is necessary for the virgin coconut oil component to have a good flavor profile and not to have any of the flavor profile removed by processing the oil. Nature's Flavors supplies a kosher virgin coconut oil that has good flavor and works well within the present invention.

### Blackberry Powder Component

The composition of the present invention includes a blackberry powder component at 0.003% to 3% of said invention. This blackberry powder component makes up part of the flavor profile that has a synergistic effect on the high cocoa dark chocolate compositions. The blend of flavor components is a critical aspect of how the present invention accomplishes the improved taste, texture, melt, creaminess and reduction in bitterness of the compositions. Therefore, it is necessary for the blackberry powder component to have a specific flavor profile and Decas Botanicals supplies the current blackberry powder component. Other blackberry powder's can be substituted for the Decas Botanicals product, but the blackberry powder would need to have similar characteristics. While blackberry powder is the preferred flavor ingredient in the present invention other berry powders could be used including; raspberry, Marion blackberry, black raspberry, or other berry powders that can produce the same taste profile as the blackberry powder does with the present invention.

The blackberry powder can be used in its current milled form at 60 mesh or the blackberry powder can be milled to 120 mesh or higher that will allow the blackberry powder to blend completely into the high cocoa dark chocolate without having a additional grit added to the high cocoa dark chocolate compositions.

### Acai Berry Extract Component

The composition of the present invention includes an Acai Berry Extract component at 0.002% to 0.005% of said invention. This Acai Berry Extract component makes up part of the flavor profile that has a synergistic effect on the high cocoa dark chocolate compositions. The blend of flavor components is a critical aspect of how the present invention accomplishes the improved taste, texture, melt, creaminess and reduction in bitterness of the compositions. Therefore, it is necessary for the Acai Berry Extract to have a specific flavor profile and Jarchem a botanical material supplier in New Jersey distributes this product. Other Acai Berry Extract products can be used, but it would be important that these Acai Berry Extract products would need to have similar taste profiles.

### Supplement Component

Additionally, embodiments of the compositions of the present invention can include at least about 0% or greater, by weight of the composition, a supplement component such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition of the present invention can include from about 0% to about 25%, alternatively from about 0% to about 10%, and alternatively from about 0% to about 5%, by weight of the composition, of a supplement component.

### Preservative Components

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0% to 2%, by weight of the composition, a preservative component from above and or mixtures of preservatives above.

The combination of the antioxidant blend of vanilla powder, virgin coconut oil, blackberry powder and Acai Berry Extract have a synergistic effect on the taste, texture, and melt, and creaminess while substantially to in some cases completely removing the bitterness in high cocoa dark chocolate. Embodiments within this invention that utilize this synergistic antioxidant blend flavor profile create high cocoa dark chocolate that has the taste, texture, and melt characteristics similar to milk chocolate. These improved taste characteristics of certain embodiments within this invention have the ability to switch consumers to eating a substantially healthier dark chocolate product compared to eating milk chocolate because of these improved taste characteristics. The antioxidant blend of vanilla powder, virgin coconut oil, blackberry powder, and Acai Berry extract add additional healthy characteristics including antioxidants to high cocoa dark chocolate when added into the formulas as well.

### Form of Composition

The compositions of the present invention can be formed into any suitable confectionery form. Non-limiting examples of the form of the compositions include: bite size pieces, squares or rectangles of specific weight, varying molded shapes or sizes including bars and tablet bars that are available for chocolate confectionery products. The compositions can be used for enrobing purposes or for combination food products that utilize high cocoa dark chocolate as an ingredient.

### Method of Making

Example methods of preparing compositions of the present invention can comprise steps selected from the steps of: an embodiment of the present invention is a composition comprising the steps of: a. melting the standardized high cocoa dark chocolate and chocolate liquor if necessary tempering it in a mixing vessel or then putting it into a mixing vessel; b. adding the virgin coconut oil to the mixing vessel; c. adding the vanilla powder component to the mixing vessel; d. adding blackberry powder in the mixing vessel; e. adding the Acai berry extract component to the mixing vessel and mix until a homogeneous mixture.

Additionally, an embodiment of the present invention is a composition comprising the steps of: a. melting the standardized high cocoa dark chocolate and chocolate liquor if necessary tempering it in a mixing vessel or then putting it into a mixing vessel that can keep the temperature at 92 degrees Fahrenheit or higher; b. adding the virgin coconut oil to the mixing vessel; c. adding the vanilla powder component to the mixing vessel; d. adding blackberry powder in the mixing vessel; e. adding the Acai berry extract component to the mixing vessel and mix until a homogeneous mixture.

While the above method utilizes an already made standardized dark chocolate and chocolate liquor as ingredients in the above described method of creation, the method of creating the standardized dark chocolate could be altered to include making the composition all at once at the time of initial dark chocolate product creation. In this case all of the above ingredients would be added together in the process to create the standardized dark chocolate composition from the bench up and would avoid the necessity of double blending.

The final mixture can be made using a traditional chocolate molding line. The final compositions will be either made into molded squares or bars or other molded shapes by the traditional chocolate molding line. The squares or bars or shapes produced would be flow wrapped into foil wrappers or foiled with wrapper such as is standard for confectionery chocolate squares or bars in the industry. These packaged individual squares or bars can then be placed in secondary packaging, non-limiting examples include cartons, bags, pop boxes, or sleeves; and combinations thereof.

### EXAMPLES

The below examples are included for illustrative purposes only and are not intended to in any way limit the scope of the present invention.

### Example 1

### Dark Chocolate with Improved Taste, Texture, Melt, and Substantially Lower Bitterness than Regular Dark Chocolate and Addition of Beneficial Antioxidant Blend

At room temperature add 12.8 ounces of Tulsa Dark brand dark chocolate supplied by Barry Callebaut to a melting confectionery mixer that can also temper the chocolate. Melt and temper the dark chocolate and keep it at 92 degrees Fahrenheit to maintain tempered state. Then add 12 grams of vanilla powder. Then add 12 grams of virgin coconut oil. Then add 4 grams of blackberry powder. Then add 1.3 grams of Acai Berry Extract to the mixing vessel. Mix the ingredients until completely homogeneous. The blended Dark Chocolate would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This same formula can be increased at same percentage levels for large scale production using standard confectionery molding processes.

### Example 2

70% Cocoa Dark Chocolate with Improved Taste, Texture, Melt, and Substantially Lower Bitterness than Regular Dark Chocolate and addition of beneficial antioxidant blend

At room temperature add 12.8 ounces of Tulsa Dark brand dark chocolate supplied by Barry Callebaut to a melting confectionery mixer that can also temper the chocolate. Then add 1.2 ounces of SR22 Chocolate Liquor sold by Barry Callebaut to the confectionery mixer. Melt and temper the dark chocolate and chocolate liquor and keep it at 92 degrees Fahrenheit to maintain tempered state. Then add 12 grams of vanilla powder. Then add 12 grams of virgin coconut oil. Then add 4 grams of blackberry powder. Then add 1.3 grams of Acai Berry Extract to the mixing vessel. Mix the ingredients until completely homogeneous. The blended 70% Cocoa Dark Chocolate would then be deposited in molds that make 3 oz. bars and refrigerated for at least 40 minutes to allow the chocolate to set. The bars would then be ejected out of the mold and can be flow wrap packaged or foil with wrapper packaged in a standard confectionery packaging machine. The bars would then be packed into secondary packaging of a pop display box. This same formula can be increased at same percentage levels for large scale production using standard confectionery molding processes.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An improved health characteristic and antioxidant content reduced bitterness, improved taste, improved melt, improved texture, synergistic antioxidant blend, lower saturated fat higher cocoa non-standardized dark chocolate composition comprising; a. a dark chocolate component at 40% or greater, by weight of said composition; b. 0% to 30% a chocolate liquor component, by weight of said composition; c. a virgin coconut component at 0.001% to 5%, by weight of said composition; d. 0.001% to 5% a vanilla powder component, by weight of said composition; e. 0% to 4% a Blackberry Powder component, by weight of said composition; f. 0% to 1% a Acai Berry extract component, by weight of said composition; g. 0% to 15% an edible oil component with a high level of unsaturated fatty acids, by weight of said composition; h. 0% to 20% a 100% cocoa component, by weight of said composition; i. 0% to 20% a confectionery sugar component, by weight of said composition; j. 0% to 4% Cocoa Seed Butter crystals that support set of chocolate structure, by said composition; and k. at least 0% to greater of a supplement component, by weight of said composition.

2. An improved health characteristic and antioxidant content reduced bitterness, improved taste, improved melt, improved texture, synergistic antioxidant blend standardized dark chocolate composition comprising; a. a dark chocolate component at 40% or greater, by weight of said composition; b. 0% to 30% a chocolate liquor component, by weight of said composition; c. a virgin coconut component at 0.001% to 5%, by weight of said composition; d. 0.001% to 5% a vanilla powder component, by weight of said composition; e. 0% to 4% a Blackberry Powder component, by weight of said composition; f. 0% to 1% a Acai Berry extract, by weight of said composition, g. at least 0% to greater of a supplement component, by weight of said composition.

3. The composition of claim 1 and claim 2 wherein said dark chocolate component has a cocoa percentage from 40% to 90%, by weight of said dark chocolate component.

4. The composition of claim 1 and claim 2 wherein the dark chocolate component has milk or has no milk content.

5. The composition of claim 4 wherein the dark chocolate component has no milk content.

6. The composition of claim 1 and claim 2 wherein the dark chocolate component is natural with no artificial flavors or isn't natural and has artificial flavors.

7. The composition of claim 6 wherein the dark chocolate component is all natural and has no artificial flavors.

8. The composition of claim 1 and claim 2 wherein the dark chocolate component is processed with alkali or isn't processed with alkali.

9. The composition of claim 8 wherein the dark chocolate component isn't processed with alkali.

10. The composition of claim 1 and claim 2 wherein said dark chocolate is 40% to 45%, alternatively 45% to 50%, alternatively 50% to 55%, alternatively 55% to 60%, alternatively 60% to 65%, alternatively 65% to 70%, alternatively 70% to 75%, alternatively 75% to 80%, alternatively 80% to 85%, alternatively 85% to 90%, alternatively 90% to 95%, alternatively 95% to 99%, by weight of said composition.

11. The composition of claim 1 and claim 2 wherein the chocolate liquor component is all natural with no artificial flavors or isn't all natural and has artificial flavors and has no milk fat or has milk fat and isn't processed with alkali or is processed with alkali.

12. The composition of claim 11 wherein the chocolate liquor component is all natural, has no milk fat, and isn't processed with alkali.

13. The composition of claim 1 and claim 2 wherein the chocolate liquor component is 0% to 30%, by weight of said composition.

14. The composition of claim 1 and claim 2 wherein the virgin coconut oil component is 0.001% to 5%, by weight of said composition.

15. The composition of claim 1 and claim 2 wherein the vanilla powder component is 0.001% to 5%, by weight of said composition.

16. The composition of claim 1 and claim 2 wherein the blackberry powder is 0% to 4%, by weight of said composition.

17. The composition of claim 16 wherein the blackberry powder is replaced with a berry powder from the group including raspberry, black raspberry, and Marion blackberry or a combination of these different berries or a combination of blackberry powder and these different berry powders or a berry powder that has similar taste profile.

18. The composition of claim 1 and claim 2 wherein the Acai Berry extract is 0% to 1%, by weight of said composition.

19. The composition of claim 1 wherein an edible oil component is 0% to 15%, alternatively 10% to 15%, alternatively 5% to 10%, alternatively 0% to 5% with a high level of unsaturated fatty acids, by said composition.

20. The composition of claim 19 where the edible oil component comes from the group of edible oils including; canola oil, soybean oil, safflower oil, sunflower oil, sesame oil, walnut oil, olive oil, flaxseed oil, chia seed oil, almond oil, corn oil, grape seed oil, peanut oil, other nut oils, and combinations thereof or other suitable edible oils that have a high level of unsaturated fatty acids.

21. The composition of claim 19 wherein the edible oil is a blend of canola, soybean oil, and sunflower oil.

22. The composition of claim 19 wherein the edible oil is a blend of canola, soybean, and olive oil.

23. The composition of claim 1 wherein a 100% Cocoa component is 0% to 20%, alternatively 15% to 20%, alternatively 10% to 15%, alternatively 5% to 10%, alternatively 0% to 5%, by weight of said composition.

24. The composition of claim 23 wherein a 100% Cocoa component comes from the group of defatted 100% Cocoa, low fat or 12% fat or less 100% Cocoa, fully fatted 100% cocoa 12% or higher fat content, and dutched or processed with alkali 100% Cocoa defatted, low fat 12% fat or less, and fully fatted 12% or higher fat content.

25. Composition of claim 23 wherein a not 100% cocoa is replaced for the 100% cocoa ingredient at 0% to 20%, by weight of said composition.

26. The composition of claim 24 wherein the 100% Cocoa component has a low fat content of 12% or less.

27. The composition of claim 1 where the confectionery sugar component is 0% to 20%, alternatively 15% to 20%, alternatively 10% to 15%, alternatively 5% to 10%, alternatively 0% to 5%, by weight of said composition.

28. The composition of claim 1 wherein a cocoa seed butter crystals component that can improve the chocolate set structure is 0% to 4%, by weight of said composition.

29. The composition of claim 1 wherein a supplement component is 0% or greater, by weight of said composition.

30. The composition of claim 29 wherein the supplement component comes from the group consisting of: vitamins, minerals, herbs, botanicals, essential fatty acids, seeds, plant derived supplements including sterols and stanols, animal derived supplements, therapeutic compounds, and mixtures thereof; by weight of said composition.

31. The composition of claim 1 wherein certain ratios of ingredients create an improved health characteristic, synergistic higher antioxidant content blend, reduced bitterness, improved taste, improved melt, improved texture, creamier tasting, lower saturated fat, higher cocoa non-standardized dark chocolate composition that can have up to 75% less saturated fat content than regular high cocoa dark chocolate.

32. The composition of claim 1 wherein certain edible oils chosen for the composition are high in unsaturated fat especially polyunsaturated fat like the essential fatty acids Omega 6 linoleic and Omega 3 ALA's alpha-linolenic; canola oil, walnut oil, chia seed oil, flaxseed oil, grape seed oil, etc. create an improved health characteristic, synergistic higher antioxidant content blend, reduced bitterness, improved taste, improved melt, improved texture, creamier tasting, lower saturated fat, higher cocoa non-standardized dark chocolate composition that can have 25% to 75% less saturated fat content than regular high cocoa dark chocolate and that has better balance between saturated, monounsaturated, and polyunsaturated fats.

33. The composition of claim 31 and claim 32 would comprise the following:
a. 40% to 65% a high cocoa dark chocolate component
b. 0% to 30% a chocolate liquor component
c. 0.001% to 5% virgin coconut oil component
d. 0.001% to 5% vanilla powder component
e. 0% to 4% blackberry powder component
f. 0% to 1% acai berry extract component
g. 5% to 15% edible oil component (blend of canola, soybean, and sunflower)
h. 5% to 20% 100% cocoa powder component
i. 5% to 20% confectionery sugar component

34. The composition of claim 33 wherein a supplement component is added to the composition.

35. The composition of claim 34 wherein the supplement component is 0% or greater Omega 3 DHA/EPA, by weight of said composition.

36. The composition of claim 34 wherein the supplement component is 0% or greater plant sterols, by weight of said composition.

37. The composition of claim 34 wherein the supplement component are both Omega 3 DHA/EPA at 0% or greater and plant sterols at 0% or greater, by weight of said composition.

38. The composition of claim 2 wherein certain ratios of ingredients produce an improved health characteristic, synergistic higher antioxidant content blend, reduced bitterness, improved taste, improved melt, improved texture, creamier tasting standardized higher cocoa dark chocolate or dark chocolate composition.

39. The composition of claim 38 would comprise the following:
a. 80% to 95% high cocoa dark chocolate component
b. 0% to 30% chocolate liquor component
c. 0.001% to 5% vanilla powder component
d. 0.001% to 5% virgin coconut oil component
e. 0% to 4% blackberry powder component
f. 0% to 1% acai berry extract component

40. The composition of claim 39 wherein a supplement component is added to the composition.

41. The composition of claim 40 wherein the supplement component is 0% or greater Omega 3 DHA/EPA.

42. The composition of claim 40 wherein the supplement component is 0% or greater plant sterols, by weight of said composition.

43. The composition of claim 40 wherein the supplement component are both Omega 3 DHA/EPA at 0% or greater and plant sterols at 0% or greater, by weight of said composition.

44. The composition of claim 1 and claim 2 wherein said composition comprises a form selected from the group consisting of: bite size pieces, squares or rectangles of specific weight, varying molded shapes or sizes that are available for chocolate confectionery products including bars and larger tablet bars, a coating for a confectionery or food, an enrobing material for confectionery or food, a layer for a confectionery or food, and an ingredient for a confectionery or food.

45. A method of preparing a composition of claim 31 and claim 32 wherein certain ratios of ingredients create an improved health characteristic, synergistic higher antioxidant content blend, reduced bitterness, improved taste, improved melt, improved texture, creamier tasting lower saturated fat non-standardized high cocoa dark chocolate composition that can have 25% to 75% less saturated fat content than regular high cocoa dark chocolate and an improved balance of saturated, monounsaturated, and polyunsaturated fats comprising the steps of: a. melting the high cocoa dark chocolate component and chocolate liquor component if necessary and tempering it in a mixing vessel or then putting it into a mixing vessel that can maintain 92 degrees Fahrenheit in order to keep the chocolate component tempered; b. add the vanilla powder component to the mixing vessel; c. add the blackberry powder component to the mixing vessel; d. add the Acai berry extract to the mixing vessel if necessary; e. add the supplement component if necessary and blend until completely homogeneous. In a separate mixing vessel; a. add the edible oil component; b. add virgin coconut oil component; c. add the confectionery sugar component and heat until they reach a temperature sufficient to completely melt the sugar and blend until ingredients are homogeneous; d. then add the 100% Cocoa component to second mixing vessel and blend until homogeneous and letting cool until it reaches 92 degrees Fahrenheit. Then add contents of second mixing vessel that include the edible oil component, virgin coconut oil component, 100% Cocoa component, and confectionery sugar component to the first mixing vessel that includes the melted and tempered high cocoa dark chocolate component, the chocolate liquor component if necessary, vanilla powder component, blackberry component and acai berry extract component if necessary, and supplement component if necessary and blend the final mixture together until completely homogeneous; thus, creating a double blended non-standardized high cocoa dark chocolate composition that has the above listed characteristics. While the above method utilizes an already made standardized dark chocolate and chocolate liquor as ingredients in the above described method of creation, the method of creating the non-standardized dark chocolate could be altered to include making the composition all at once at the time of initial chocolate product creation. In this case all of the above ingredients would be added together in the process to create the non-standardized dark chocolate composition and would avoid the necessity of double blending. This method would lose some of the affect that the double blending creates in texture and creaminess, but would still have the same above listed advantages in claim 1.

46. The method of claim 45 further comprising the step of adding an additional component selected from the group consisting of a flavor component, a color component, a preservative component, and mixing until the above mixture becomes homogeneous with the additional listed components.

47. A method of preparing a composition of claim 38 where certain ratios of ingredients create an improved health characteristic, synergistic higher antioxidant content blend, reduced bitterness, improved taste, improved melt, improved texture, creamier standardized high cocoa dark chocolate composition comprising the steps of: a. melting the high cocoa dark chocolate component and chocolate liquor component if necessary and tempering it in a mixing vessel or then putting it into a mixing vessel that can maintain a temperature of 92 degrees Fahrenheit so the chocolate component remains tempered; b. add the vanilla powder component to the mixing vessel; c. add the virgin coconut oil component to the mixing vessel; d. add the blackberry powder component if necessary; e. add the Acai berry extract component if necessary to the mixing vessel and blend; f. add the supplement component to the mixing vessel if necessary and blend until completely homogeneous; thus, creating a standardized high cocoa dark chocolate or dark chocolate composition that has the above listed characteristics. While the above method utilizes an already made standardized dark chocolate and chocolate liquor as ingredients in the above described method of creation, the method of creating the standardized dark chocolate could be altered to include making the composition all at once at the time of initial dark chocolate product creation. In this case all of the above ingredients would be added together in the process to create the standardized dark chocolate composition from the bench up and would avoid the necessity of double blending.

48. The method of claim 47 further comprising the step of adding an additional component selected from the group consisting of a preservative component, and mixing until the above mixture becomes homogeneous with the additional listed components.

49. The method of claims 45 and claims 47 further comprising the step of processing said final mixture via a chocolate molding line into molded squares, other chocolate molded shapes, bars, or tablet bars. These molded chocolate products would be either flow wrap packaged or envelope wrap packaged or foil and wrapper packaged based on the type of product being created. These wrapped confectionery products would then be packaged in secondary packaging including but not limited to bags or cartons, pop boxes, sleeves, or other chocolate confectionery packaging containers. Or using the composition for a coating for a confectionery or food, an enrobing material for confectionery or food, a layering material for a confectionery or food, or an ingredient for a confectionery or food.
